(19) United States
(12) Patent Application Publication
(10) Pub. No.: US 2025/0165500 A1
(43) Pub. Date: May 22, 2025

(54) Congruent Quantum Data Architecture Method (CQDAM)

(71) Applicant: Darreck Lamar BENDER, II, Austin, TX (US)

(72) Inventor: Darreck Lamar BENDER, II, Austin, TX (US)

(21) Appl. No.: 18/512,087

(22) Filed: Nov. 17, 2023

(51) Int. Cl. G06F 16/28

(52) U.S. Cl. CPC G06F 16/283; G06F 16/285

(57) ABSTRACT

This disclosure generally relates to the application of a multidisciplinary data science theory that serves as an architectural framework for the enrichment and optimization of modern data warehousing practices. This data architecture method leverages the concept of spatial dimensions as defined in physics to classify and correlate information elements collected and distributed across various networks, systems, and data warehouses. Structuring data in this format will significantly reduce the energy and capacity requirements for data calls, compute functions and storage instances. The proposed data architecture concept will be applied to enhance the performance of a multiplicity of products and services across the software and hardware engineering spectrum. The Congruent Quantum Data Architecture Method will serve as an infrastructural data protocol to enable the execution of multi-dimensional functions in autonomous measurement systems and various computation apparatuses.

A computational engineering practice that leverages properties of dimensional classes as defined in physics to create a data architecture that increases computational efficiency and decreases the amount of computational power and capacity necessary to process large datasets between various types of systems. A computational engineering practice that serves as a baseline for establishing computational congruence between source systems, data warehouses, and measurement systems. A computational engineering practice that produces an easily integrated architectural framework to establish ethical and legally complaint data processing protocols in large scale data-intensive environments. A computational engineering practice that formalizes disparate datasets by quantifying the amount of energy a data element possesses within a system to produce a computationally congruent data ecosystem.

A data warehousing architecture method that classifies information based on usage capabilities as defined by the energy the information element possesses within a system. A data processing method that optimizes Extraction, Transform, Load (ETL) process by leveraging a one-to-one unified data architecture across source systems, data warehouses, and software services. A data processing method that serves as the infrastructural basis for establishing a real time feedback loop across source systems, data warehouses, and measurement systems. A data processing method that increases the utility of software services of all kinds by creating a one-to-one data relationship and hierarchical baseline across data inputs, outputs and computational functions. A data processing method that optimizes the collection, storage, computation, and utilization of large sets of data in cloud environments through the classification of data elements by dimensions as represented in physics.

A computational engineering practice that increases the speed of internal system calls, database queries and API calls through the organization of referential data and objects by dimension as defined in physics. A computational engineering practice that serves as an optimization to relational and non-relational data modeling by creating a classification baseline that allows user activity within a system to determine data relativity and circumstantial relationship occurrences across disparate datasets. A computational engineering practice that leverages concept of the degrees of freedom as defined in biology to pre-determine the computational capacity necessary to execute a computation within a system or a collection of systems. A computational engineering practice that increases the utility of data insights across a technology infrastructure by categorizing information elements and correlated objects by the amount of energy the value represents within a system. A data computation practice that serves as a multiutility framework for establishing the infrastructural maturity to leverage artificial intelligence and machine learning compute functions in enterprise technology environments in an ethical and legally compliant way.

### BACKGROUND OF INVENTION

The evolutionary development of computer science, data science theory and the applied practices thereof have proliferated at the speed necessary to support transformative paradigm shifts in business, scholastic research, and technological development. The foundational principles of modern computation are derived from various scientific methods developed before and during the Industrial Revolution. These improvements were built to optimize the performance of mechanical tools designed to execute a pre-defined task. The application of the early scientific discoveries foundational to computational sciences were originally purposed to influence a significant reduction in operational cost for the manufacturing domain during the industrial era. Various innovations developed during this moment in time defined the practical standards of the industrial applicability and commercialization of theoretical sciences through product development and engineering. This defining moment in innovation enabled a holistic socialization of scientific development and applied practice within the theoretical innovation community at the global level. A byproduct of this pivotal moment in history was the enablement of multidisciplinary collaboration across science and engineering research. Subsequently this became the framework of the open-source culture in scientific research and advanced technology that exist today.

A large percentage of the software and/or mechanical products that exist in the market today are derivative works of foundational innovation research completed in the industrial and pre-industrial age. There is evidence that suggest that the theory of binary numbering system has been studied since ancient times by various cultures including India, Egypt, and China. There is also evidence of instances of isolated research in Europe associated with binary numeration during the 16^{th} and 17^{th} centuries. Ultimately the discovery would be accredited to German mathematician and scientist Gottfried Wilhelm Leibniz. In 1689, Gottfried Wilhelm Leibniz published a scientific article titled “Explanation of Binary Arithmetic” which contained a high-level functional framework to covert verbal logic statements into mathematical statements. Leibniz made refinements to the framework outlined in his publication over the course of his scientific career, and this discovery would later serve as a foundational principal of computer science and language. In Leibniz's subsequent publications he would describe the various theoretical applications for the binary numbering system detailing various types of computational machines that could be developed as a result of his discovery. The industrial application of the binary numbering system didn't occur until 8 years after Leibniz's death.

In 1725, a textile engineer, Basile Bouchon developed a way to feed machines a compound set of instructions built on binary numeric principles to execute a list of pre-determined task. This discovery was necessary to develop complex system logic and modern computer language. The innovation served as a paramount contribution to the optimization of industrial machines and enabled the existing mechanical framework to interpret instructions communicated through a series of binary sequences. The inventions of Basile Bouchon influenced a series of subsequent discoveries associated with the enablement of mechanical infrastructure perform semi-autonomous functions based on one dimensional command sequences. Basile's invention was a major catalyst for inventors like Jean Baptiste Falcon and Jacques Vaucanson to continue to iterate and optimize the industrial application of the binary sequencing method. In 1804, Joseph Marie Jacquard revealed that he discovered a way to use the previous research in binary sequencing to power his textile machine called the “Jacquard Loom”. Jacquard patented the invention and made subsequent improvements to the machine as he was granted a lifetime pension from the Emperor of Lyon, France for his discovery.

The core concept of the engineering practice developed by Jacquard enabled the growth of large-scale textile manufacturing during the industrial age. The components of the engineering practice included:
a machine capable of performing a specified task or series of task
   machine is enabled by linear functions derived from 0 and 1
a sequence of instructions that communicate linear task to machine
   instructions can be compounded to communicate the execution of a series of one-dimensional task in consecutive order
   instructions must produce one of two specific outcomes per command
the identification of the baseline capabilities executed through the range of functions that exist within a machine
   The mechanical engineering framework developed by Jacquard was used to enable the growth and utility of textile factories on a global scale. Additionally, Jacquard was later credited with laying the groundwork and influencing the creation of the foundational principles of modern computation.

The foundational inventions, research, theoretical scientific concepts that shaped the trajectory of modern computer science were expanded in 1834 through the innovations developed by English mechanical engineer, Charles Babbage. The core functions of Charles's inventions such as the difference analytical and the analytical engine paved the way for commercial computation products like Microsoft Excel which core functions rely on sorting and computing basic math in data tables to deliver value to end users. Both inventions were capable of quantifying mathematical inputs, and the utility of both inventions were enabled by leveraging the binary mechanical framework created by Joseph Jacquard in previous years.

The invention of analytical machine ultimately shifted the paradigm of possibilities in computational and mechanical engineering. During the development of the Analytical Machine, Babbage corresponded with mathematical scholar, Ada Lovelace who was credited with the creation of the first algorithmic method to execute the computation mathematical complex functions using a mechanical apparatus. The theories and principles contained in the combined discoveries of Charles Babbage, Ada Lovelace and Joseph Jacquard were credited as foundational utilities of computer science and would serve as a commonly used framework in the development of future innovations. The concepts were certainly of relevance in the Second Industrial Revolution, but the arch of the ripple effect of these innovations would be most prominent in the Third Industrial Revolution (Digital Revolution).

English mathematician, George Boole later developed a method to expand of functional capabilities of a system through the application of his algebraic framework “Boolean Algebra”. At the core of Boole's algebraic framework are binary operations that drive a collection of binary states used to execute complex questions with one-dimensional context, yes or no, which concatenates systemically as a 0 or 1. Boole's framework expanded of communication capabilities of mechanical apparatuses though using both binary operation and a unary operation to solve complex problems.

Software engineers use a combination of complex binary and unary operations to develop complex algorithms that can perform multidimensional functions to express a one-dimensional action or result. The function of an algorithm is to communicate a series of instructions to a system for the purpose of executing an outcome. The system reads the instructions, then uses a set of functions powered by the logic gate to trigger the execution of the instructions outlined in the algorithm to produce a binary result. Programming languages have various classes and functions that communicate to a specific part of a system. Software programs often contain language from various classes that execute a series of complex functions that have the capacity to produce three-dimensional task value.

An example of this can be an analytics platform that ingests data from various sources, uses an algorithm to compute qualitative results and display the business insights on a company dashboard. The software platform itself appears to perform a three-dimensional task but sequences several one-dimensional commands to call and return each intricate detail outlined in the instructions communicated by the programming language. This approach may be appropriate for executing linear quantitative analysis where the desired output of the system is an absolute value being analyzed retrospectively. All modern computations expressed as real time functions are executed along a linear, one-dimensional path as they use a set of instructions to reference a pre-determined repository to process a near real-time result. However, executing a computation that is subject to conditional interdependencies and circumstantial relativity necessitates the utilization of a practice that allows for the measurement conditions to change as the computational conditions of the observation and its environment changes.

To successfully architect a system designed to execute computations that enable real-time functions that react to conditional variances, each component of the system architecture that supports the computation of conditional logic states within the system must be expanded to capture a broader spectrum of information. To holistically expand the spectrum of information observed by a system, the following components of the modern computer must be modified: the data architecture, the computer language and logic hardware. While the CQDAM only represents one aspect of the refinement of information processing within computational systems, addressing this focus area first will inform the innovation path for computer language and hardware. By integrating CQDAM protocols into current technology architecture and software platforms organizations will have the ability to extract a plethora computational of value through an exponential increase in processing speeds and the enablement of deeper operational insights.

The sequencing the CQDAM as the first industrially applied component of the Congruent Quantum Computation Series creates an opportunity to test and refine protocols at scale while delivering value to the cloud computation marketplace with distinctions to data architecture design and measurement analytics. This approach will be leveraged to design frameworks to automate the compliance of consumer data privacy laws in data-intensive computation environments, and to inform the curation of best practices for the development of legally and ethically compliant artificial intelligence and machine learning technologies. The CQDAM optimizes the “Star” data warehousing method and the “Snowflake” method through the application of various architectural design functions that can be applied consistently across variable data elements and objects to normalize information at scale.

The proposed data science theory outlines a method for categorizing information within a system or collection of systems that would enable the expansion of the functional capabilities of a system(s), a mechanical apparatus, and the communication medium between the two. This data architecture method is a derivative work of the Congruent Quantum Computation Theory (PCT/US23/11294), independently invented and patented by me in 2022. This optimization of computer language through data architecture design will result in an increase the speed of data detection, data categorization, and advanced analytics.

### SUMMARY

Classic computation theory uses the observation of binary numbers in various infrastructural components of hardware and software products to trigger functions that use linear quantifiers to drive complex decisioning models within a system. The quantifying events processed within a system are limited to a total of 1 of 2 outcomes at a time and are expressed as a 0 or 1. Principles and concepts that define the range of functionality within modern computational products are derived from mechanically influenced engineering design concepts. The limitations that influenced the mechanical capabilities at the time that the founding principles of computer language were developed no longer hold the same relevance as they did in the industrial age. As the commercial use of classic computation products expanded, so did the utility of the information collected by a system, which directly influenced the expansion of the range of potential capabilities within newly designed systems. Information derived from computation products have a multidimensional utility that has redefined the way products and services are delivered to customers.

In the modern age of classical computing, users have access to a variety of experiences online that produce exceptionally large amounts of data at scale. The insights contained in the data elements collected online present enterprises either an opportunity to increase operational intelligence to decrease operational cost, or a compounding increase in operational cost for the maintenance, analysis, and storage of the information. For example, data-intensive ecommerce organizations manage several instances of complex data structures that rely on very intricate routing of inputs and outputs to execute functions that enable experiences for customers. Due to the lack of architectural consistency across systems, inputs and outputs that are native to one system may appear as unstructured to another. As the occurrences of normalization of data across various platforms increase, so does the time, space, and energy requirement, and subsequently the operational cost to the enterprise.

Data warehousing practices that are used commercially across enterprises include the snowflake method, and the star method. Both methods outline a framework for general data classification in a system but rely on an extensive process of normalization to enable the functional use of the information when referencing data across various systems. Conceptually, the design of both data architecture methods offers a functional framework that can be used to organize various types of information across disparate, yet interconnected technology systems. However, due to the architectural inconsistences across the systems within the infrastructure, various environments often produce results that have the necessity to be restructured to make the data useful again. To extract insightful value from the data, the disjointed information must be recontextualized within the holistic scope the data ecosystem. This reconciliation process involves using extended budgetary and subject matter resources to create a process to formalize, streamline and manage the output of each data instance present across an enterprise architecture.

Organizations often mitigate gaps associated with data reconciliation, personalization, and measurement analytics through the licensing of various software services. These licenses are often costly and require significant internal experience with the proposed solution to independently manage the software instance successfully. Without having dedicated internal resources with a combination of the following skills, companies will have increased financial risk and exposure:
expert-level historical context of internal business operations
extensive understanding of the scope business impacts created by solution gap
significant understanding of the range of capabilities of the proposed solution
   Large enterprises most often reach success from delivering the product or service in their specialized domain, resulting in technology enablement in being a secondary or auxiliary focus to the overall business. In the modern age of business, organizations will be forced to pivot from product and service-focused companies with technology departments, to technology-focused companies that deliver industry-specific products and services, in order to stabilize long-term market presence in the future.

With the largest aggregators of data being enterprise companies that transact products and services through e-commerce platforms that host user engagement, organizations must be enabled to react to customer needs quickly. This requires integrating consistent data protocols that enhance the infrastructural maturity and agility of enterprise data, to effectively leverage modernized technology methods that enable personalized customer experiences and advanced measurement analytics. Enterprises often outsource this effort through external product and service agencies that manage the integration of the technology instance, and the ongoing output of the software. The historical context of the technology product's relationship to an organization's internal technology ecosystem, and the output of that system is often lost, which creates a compounding business intelligence gap. For an enterprise to understand more about its customer and its business, the enterprise must integrate and standardize data practices to enable deeper insights internally. By incrementally reducing the dependency on external products and services to extract value from first-party data, companies can increase their data insight ownership and visibility of the customer transaction. To accomplish an internal data overhaul that includes the restructuring of data sets across all business units within an enterprise, organizations need a technical solution that has the following characteristics:
architecturally embedded, multifunctional data normalization
consistent, multifunctional data architecture when applied across various systems
architecturally embedded, data correlation and relationship definition
architecturally embedded operational and customer analytics
   Additionally, the solution must accomplish this each of these tasks including the integration of the solution across each system in each business unit across the business, quickly and seamlessly without disrupting business operations.

Integration of the proposed data architecture will result in significant benefits including technical and operational cost reduction, data management optimization, and advanced operational insights. The following data protocols will reduce technology acquisition waste and increase the success rate of data-centric product integrations executed through vendor relationships. The CQDAM contains various architectural mechanism and functions that automate the normalization of datasets of all volumes in real-time.

Through application of the characteristics that define the elements and functions present in spatial dimensions outlined in physics, the proposed data architecture protocol eliminates data redundancy by categorizing information to a native dimension as defined by the energy a data element expresses within a system. The spatial dimensions of physics include the following basic functions for each dimension:
0-Dimensional: The zeroth dimension is represented by a point. It has no length, width, height, or any other measurement of space. A point serves as the most fundamental building block in the geometry of higher dimensions, as it defines a specific location in space but occupies no volume.
1-Dimensional: When you take two distinct points (0D) and connect them, you create a one-dimensional object called a line or a line segment if it is finite. This dimension has only length and no other spatial property. It's the simplest form of geometry that has a size (magnitude) but only in one direction.
2-Dimensional: By adding a second dimension to a line, you get a plane, which contains an infinite number of lines connected side by side. This is where concepts like shapes (triangles, squares, circles) come into play. A two-dimensional object has both length and width but no depth. It can be visualized on a flat surface, like a piece of paper.
3-Dimensional: The third dimension adds depth to the plane, creating volume. This is the dimension where objects become solids, with length, width, and height. It's the space we live in, where objects have three-dimensional geometry, allowing for real-world physical representation and spatial relationships that are intuitive to human perception.
4-Dimensional: In physics, the fourth dimension is often time, which, when added to three-dimensional space, creates what is known as spacetime. However, if we are speaking purely in terms of spatial dimensions (as in some areas of theoretical physics and mathematics), a four-dimensional space would involve a direction that is perpendicular to all three spatial dimensions. This fourth spatial dimension is not directly observable to us; we cannot intuitively perceive it. The function of the fourth spatial dimension in theoretical models is to allow for more complex and abstract relationships between geometrical and physical entities that cannot exist in three dimensional spaces

Through the application of the elements and functions described in each dimension outlined above, information can be categorized in a standardized way across various data architectures to produce transformative results in various domains public and private. The development of the CQCDAM represents a paradigm shift from traditional data warehousing methods displayed in classical computing, to introducing a unified baseline for data values that significantly enhances the potential for insightful data-driven decisions. The Congruent Quantum Data Architecture Method is phase one of the Congruent Quantum Series which serves as directive for the enhancement and transformation of classic computing and data science theory.

### DETAILED DESCRIPTION OF INVENTION

In the modern era of data warehousing and analytics, data modeling schemas such as Star, Snowflake, and Galaxy limit the spectrum of business insight and data utility through the hard-coded, predefined relationships made by the data architect at the time the system is developed. Relational database models have been very useful frameworks during the web 1.0 and 2.0 ages, specifically through the enablement of various computational functions like basic personalization, segmentation, and analytics. However, the development of autonomous systems like self-driving systems, real-time analytics, artificial intelligence, and machine learning systems necessitate an architecture that contains structural, non-structural, relational, and relative database properties.

Traditional data modeling concepts can be used in a referential capacity through the hard-coded correlation of disparate datasets to perform a predefined function; thus, limiting the ability to identify circumstantial relationships in other datasets. Additionally, within the last decade, enterprises have prioritized the expansion of their online presence to stabilize market position. As a result, non-tech organizations have increased their dependency on the purchase/license of external software products that are purposed to ingest the collected information and produce an export containing business intelligence.

(0) Dimensional Data: The computational function of 0-dimension data is display. The physics function of the 0^{th} spatial dimension is to define a space with no observed energy and serve as a baseline for higher dimensions. The data elements present in the 0-dimensional class have the function of identification management. Most common fields present in the 0-data dimension include record identifiers such as: customer name, account number, phone number, customer ID, customer address, dob and IP addresses. 0-Dimensional data elements are leveraged to identify unique users within a system or collection of systems, in which a measurable activity can be associated. 0-dimensonal data elements represented in this dimensional class are updated statically, while elements contained in higher dimensions have the propensity to be updated dynamically. 0-dimensional data elements have the necessity of being combined with data elements from higher dimensional classes to produce experiences beyond the 1^{st} dimensional realm. For example, the classic login function utilizes 0-dimensional data, expressed through 1-dimensional functions to enable the validation of 0-dimensonal data.

(1) Dimensional Data: The computational function of 1-dimensional data is position. The physics function of the 1^{st} spatial dimension is to contain information which describes linear properties of the observed energy. The data elements within this dimension defines where user fits within the holistic scope of an enterprise data ecosystem as defined by the data's observable properties. 1-dimensional data is used to further describe the characteristics an identified 0-dimension data element. Values contained within this class are fields such as: customer type, customer segment, nationality, religion, job title, salary, level of education, credit score, etc. This data dimension has a semi-static function and can occasionally updated, thus changing the position of a use within a data ecosystem. 1-dimensional data serves as the baseline of insight necessary for identifying customer segments and powering basic personalization functions, as it contains the necessary depth of insight to enable customer targeting capabilities. 1-dimensional data combined with at least one data dimension from a higher class (2-D or higher), and the unique identifiers from dimension (0-D), exemplifies the framework to produce data driven personalization experiences.

(2) Dimensional data is comprised of data elements that support the computational function of measurement. The physics function of the 2^{nd} spatial dimension is momentum. Data elements from the 2-D class are collected and correlated to 0-D data elements to create activity records that support the function of measurement. The purpose of 2-D data is to optimize personalization instances by capturing dynamic activities and identifying new data insights that may contribute to scope of information to be stored at the 1-D data layer. The 2-D data element class contains activity-based measurement information such as: website session duration, most frequently purchased products, # of user referrals, # of site visits per week, etc. The collection of 2-D data elements is enabled through the observation of various transactional occurrences within a system or collection of systems. This information is then formalized and measured against predefined benchmarks set by enterprise business partners to create the baseline of the 3-D data dimension, which executes an architecturally embedded, real-time analytics function within the data warehouse that produces business insights. The CQDAM protocols enable enterprises to draw cross-channel insights through the observation, and correlation of activities across various business verticals to identify operational interdependencies. Though the correlation of all an enterprise's system observed activities at the 2-D level, companies can use real-time measurement to inform the execution of proactive and reactive business strategies. Most web 2.0 functions are supported by the correlation of various data elements native to classes 0D-2D. Personalization function are enabled through the referencing of information represented in classes 0D-2D. In most cases enterprises capture 2-D elements in one environment, and retroactively compute analytics in a separate environment: creating an asynchronous variance in the utility of a data element and the context of the associated insight.

3^{rd} Dimension is the pre-quantum computational classification which enables functions such as next best action, pre-defined segmentation-based personalization, and advanced analytics. The physics function of the 3^{rd} spatial dimension displayed through the utilization of kinetic energy to formalize identifiable structures. In the 3^{rd} dimension, data elements are autonomously populated to produce advance analytics reports, and in parallel used to feed updates to machine learning models that generate personalized feedback loop experiences in the 4^{th} dimension. Data elements categorized at the 3^{rd} dimension include, customer click-through rate, average order amount, % of canceled or returned orders, % of products purchased in specific category vs. other categories, etc. 3-dimensional data elements enable architecturally embedded analytics capabilities that power real-time, qualitative business intelligence. As mentioned in the 2^{nd} dimension, 3-dimensional elements from various parts of a data architecture are analyzed for circumstantial relativity as defined by the observed activities and system functions triggered. The application of the 3^{rd} spatial dimension can be observed in the core computational properties of machine learning and artificial intelligence. Machine learning and artificial intelligence software programs are built to use kinetic energy executed by programming functions, data calls and compute modules to produce a 3-dimensional function confined to a binary output. Due to the predetermined intelligence architecture within the system, structures can be too detailed to capture depth of the insights observed, or structures are not detailed enough, resulting in the capture of too much uncontextualized insight depth and over-computation. 3-dimensional computation actualized in the 2^{nd}-dimension loses context in the computation and creates the reverse algorithmic variance present in most A.I. and ML environments.

4th Dimension+Beyond: is the computational function which serves experiences based upon relativity in contrast to predefined database relationships as described in the 1^{st} dimension. The function of the 4^{th} spatial dimension as defined in physics is executed through the properties of potential energy. Observation of potential energy can be measured through an establishment of a numerical hierarchy used to structure data elements 0D-3D. Activity dimensions 2-D and 3-D provide an aggregate of customer activities in comparison to measurable goals and serves information to 4-dimensional data tables to enable real-time feedback loops. Data elements contained in the 4^{th} dimension include various unstructured, semi-structured and structured information such as: customer ID photo, customer review, % of personalized products purchased, system generated qualitative personalization experience, etc. The 4^{th} dimension serves as an architecturally embedded, machine-learning feedback loop that uses information collected by data warehouse to enable the generation and transmission of personalized experiences autonomously.

### BRIEF DESCRIPTION OF DRAWINGS

FIG. 1 is a hierarchical classification the various data dimensions and the functions of the elements contained in each dimension. The 0^{th} dimension serves as the architectural baseline if the CQDAM and is comprised of record identifiers 100. The 0^{th} dimension has architecturally embedded identity management capabilities. Values contained in the 0^{th} dimension are names, ID #s, phone numbers, emails, addresses, etc. The 1^{st} dimension further enriches the architecture with descriptors 101 for the records captured in the 0^{th} dimension 100. The 1^{st} dimension has embedded segmentation capabilities as the values contained in this dimension contain a combination of user-generated, system generated and admin-generated record descriptors 101. Data elements contained in the 1^{st} dimension are customer type, job title, salary, level of education, etc.

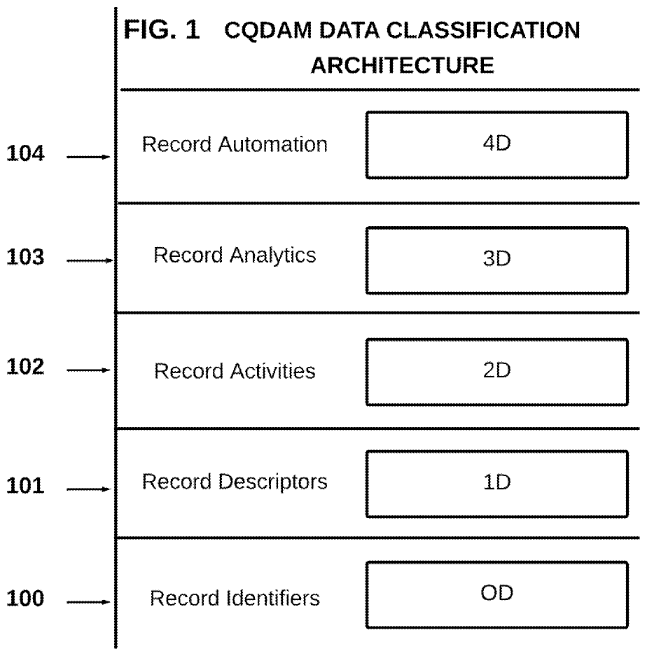

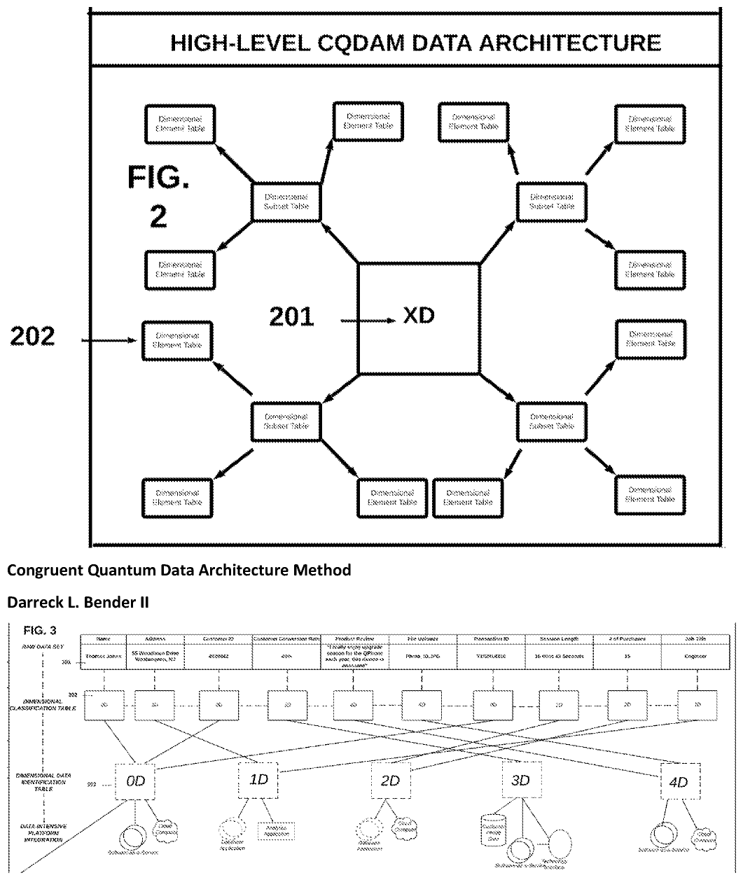

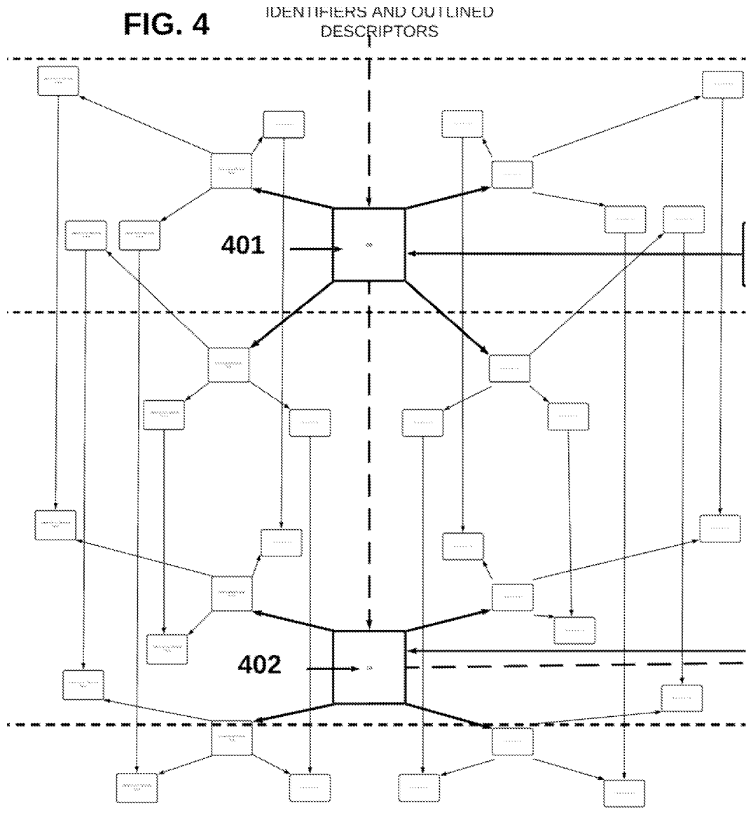

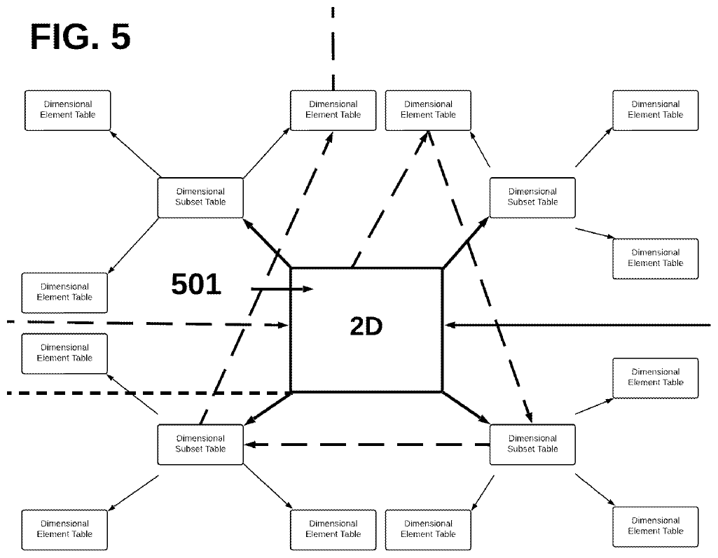

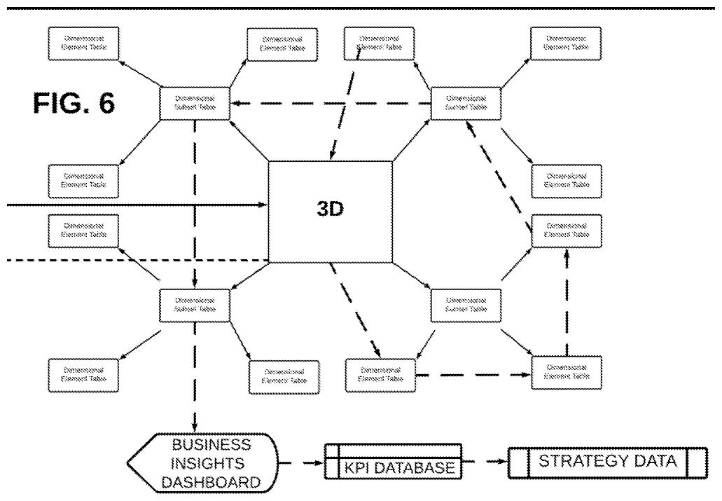

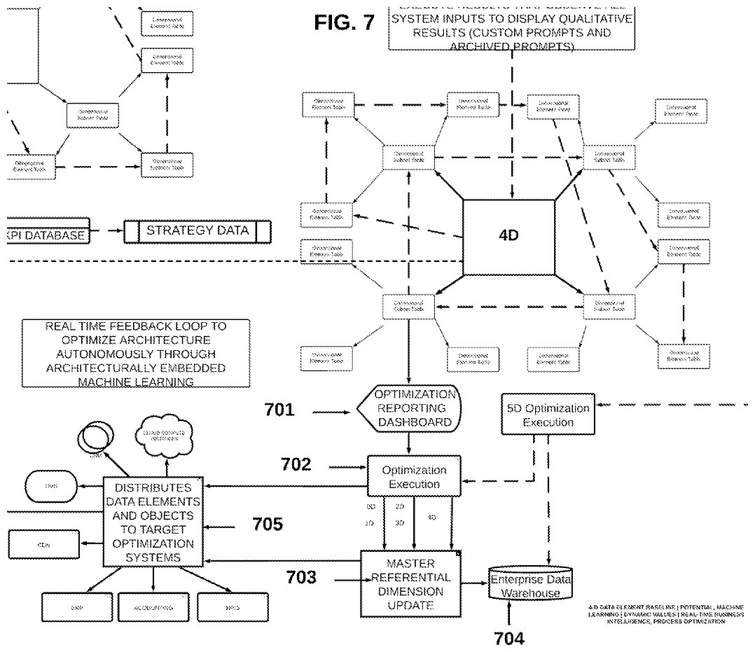

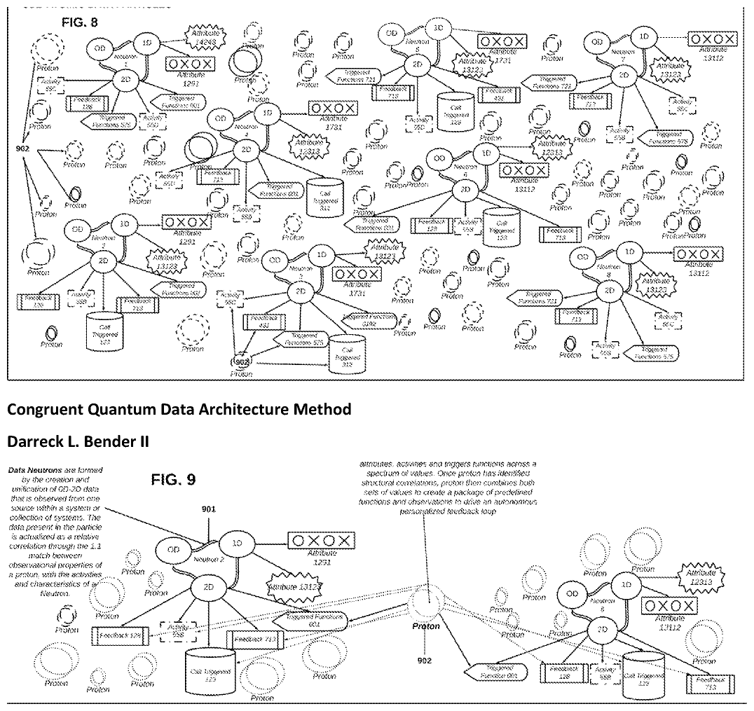

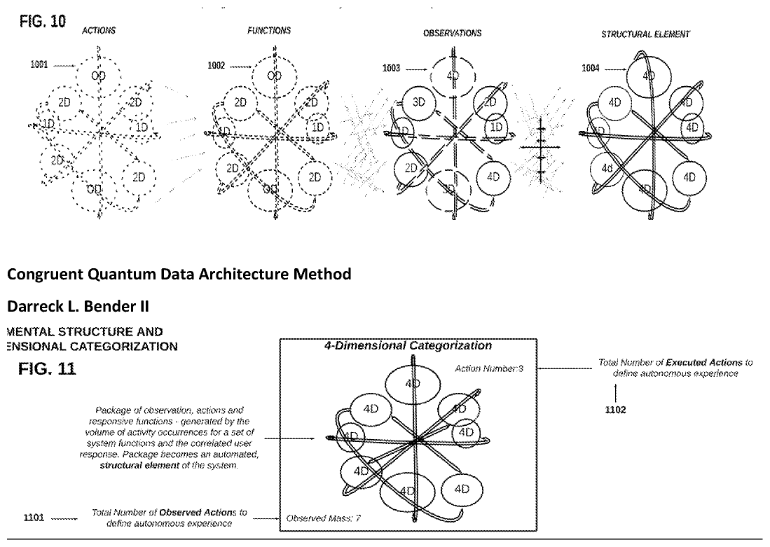

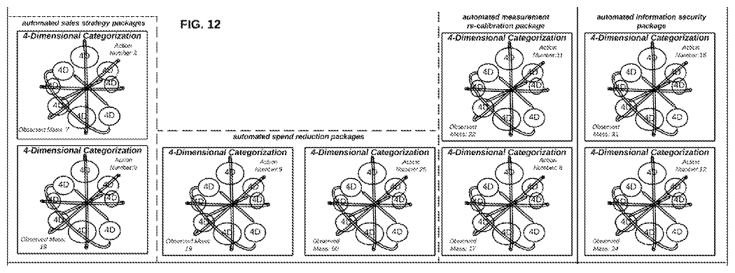

The 2^{nd} dimension captures user-generated activity and serves as the record of action for a data set present within a system 102. The function of the 2^{nd} dimension is to display a range of measurable activities observed by a system. Information in the 2^{nd} dimension serves as the architectural baseline to enable 3-D personalized experiences through the real-time data captured in online transaction platforms environments 102. Elements contained in the 2^{nd} dimension include real-time and historical measurement data such as: # of purchased products, order amount, session start/end time, # of times password has been updated, etc.

The 3^{rd} dimension enables architecturally embedded personalization and advanced analytics 103. The function of the 3^{rd} dimension is to aggregate the feed of information contained in the 2^{nd} dimension 102, against pre-defined metrics to automate the population of business insights and analytics. The 3^{rd} dimension contains information that serves as an architectural baseline for creating activity-driven personalization experiences. Elements contained in the 3^{rd} dimension include values like average session time per site visit, percentage of purchased products returned, conversion rate per session, percentage of products purchased that were previously favorited.

In the 4^{th} dimension are automated personalization models driven off data captured and fed from the 2^{nd} 102, and 3^{rd} 103 dimensions. The function of the 4^{th} dimension is to use activity data and analytics to enhance system feedback loop capabilities 104. Embedded functions of the 4^{th} dimension include machine learning capabilities that observe analytics outputs automate the recalibration of lower dimensional objects. Machine learning functions also observe data outputs of lower dimensions to formalize insights to feed the architecturally embedded artificial intelligence engine. Elements contained in the 4^{th} dimension include customer reviews, system generated feedback loop models, etc.

In the CQDAM protocol, the data architecture displayed in FIG. 2 outlines the method of normalizing data tables at a high level. The CQDAM tables contains one dimensional fact table 201 that has various sub-dimensional tables 202 that stores various elements with one dimensional utility. In FIG. 3 is the depiction of raw, unstructured data files being passed from on-premises and cloud repositories 301. Unstructured data files are then parsed into native dimensions as defined by the identified scope of utility observed with the data element 302. Once data has been parsed into its native dimension it is then classified by subject then passed to update the system of record 303. After the dimensional subject classification has been made, the primary/key foreign key relationship is developed to correlate data across subject classes native to the same dimension.

In FIG. 4 outlined is the relationship between 0-D 401 & 1-D 402 data elements. Because both dimensions contain elements that function in a linear capacity, relationships between two structures are hardcoded formalizing the relational database capabilities.

In FIG. 5 outlined is the link between 0-D,1-D+2-D activity measurement data. 2-D data dimension serves as foundation for the linkage between relative data modeling and relational data modeling through the aggregation of activities 501. Data elements captured at the 2-dimensional level are used to update measurement databases and display measurement analytics on dashboard instances. Information at the 2-D level is fed to the 3-D data level to trigger embedded analytics functions that updates in real-time.

In FIG. 6 outlined is the function of the 3-D data model that enables architecturally embedded real-time analytic functions, which feeds information to updates source systems, business insights dashboards and to the 4^{th} dimension.

In FIG. 7 outlined is the function of the 4-D data model that enables the autonomous optimization of insights driven from activities collected at the 2-D and 3-D levels. Data elements are then used enrich personalized machine learning models contained in the 4^{th} dimension. Data elements contained in this dimension include customer reviews, analytic insights regarding applied personalization models, various customer pattern analytics, etc. Data is then passed to an optimization reporting dashboard that contains various autonomously populated personalization instances generated from the holistic scope of information observed within a system or collection of systems 701. Once an admin has selected an instance from the reporting dashboard, the personalization instance is then passed to an execution environment where data is then formalized into information sets that are passed to update master referential dimensional elements 703 and enterprise data warehouse 704. In parallel system sends information packets to a distribution environment that passes each personalization instances to its native execution system 702. The establishment of dimensions beyond the 4^{th} dimension is dependent on the discovery of a previously unobserved collection of data elements that have functions and properties which combine to offer a consistent scope of utility of higher value than 4-D 705.

In FIG. 8 outlined are the various functions and components of the sub-atomic data particle level with an autonomous measurement mechanism that observes the activity measured by a system and identifies activity sequences that serve as a structural component of an enterprise's operational dataset. Akin to the observed process of the formulation of atomic structures and elements through the synthesis of protons, neutrons, and electrons, the CQDAM utilizes the atomic particle formulation principles as defined in physics to produce activity-based data relativity segments.

In FIG. 8 are various protons that appear as dashed circular objects that ocellate various 0D+1D×2D structures to identify common, polarizing, and mutual activity structures to create data relativity segments autonomously. A data proton analyzes dimensional data repositories for correlative data attributes, activities, and triggered functions across the holistic spectrum of values, then generates a complete customer segment 902.

Before a data structure has been added to at least 1 customer segment, data is considered to be sub-atomic. Data protons are enabled through various algorithmic queries which are built to analyze activity and autonomously identify instances of segmentation and then feed insights to form personalized automation.

In FIG. 9 depicts the synthesis of data neutrons 901, and protons 902. In 901, is the depiction of the creation and unification process of 0D+1D×2D data structure that mirror the functions of neutrons. Data profiles with at least 1-0D identifier, 2 or more-1D descriptors and X-2d activities are observed as neutron structures by CQDAM protocols. Through activity observation and the collection of correlated datasets, the system enables protons 902 to use algorithmic queries to produce end-to-end function trigger reports and system imprint reports for the observed set of neutrons 901. Subsequently, an atomic match is identified by the proton structure, and sub-atomic particles are combined to generate an atomic structure. At the core of the atomic structure is the context provided by the proton, this information is then used to define the scope of the utility of the personalization instance.

In FIG. 10, CQDAM protocols for the generation of an atomic data structure is an electronic process that requires 4 instances of computational analysis to form a structural component that represents the generated personalized instance, the correlated measurement observations and the source system data distribution logic. This instance of automation is a 4-D computation structure that is comprised of data native to various dimensions and algorithmic functions native to various systems.

The first stage includes a holistic analysis of all measurable activities within the sub-atomic segment (identified by the proton) which is designed to analyze all activity and triggered functions within the segment to generate a list of next-best-actions that offer experiences in context with the observed activity within the sub-atomic instance 1001.

In the second stage of generating an atomic data structure is the automated analysis of the next-best-action insight report which is used to execute the design of a range of personalization outputs calibrated to high-level goals and key performance indexes defined by the enterprise. Once a design has been identified, design specifications are leveraged to execute an algorithmic-initiated compilation and sequencing of code functions and referential sources to actualize the personalization instance 1002.

In the third stage all functions, referential data sets, and systems of execution are analyzed to design a measurement structure that is linked across all output data sources to track the performance of the personalization instance in real-time 1003. After the instance is used, the feedback loop is then fed to the “₅th” dimension (replicated₄ₜh) machine learning layer to enrich models, then analyze and recalibrate the personalized functions associated with the instance. This sequence continues as an infinite loop until new facts are discovered to define properties of a subsequent dimension.

In the fourth stage a compilation of the personalization functions defined in stage two and the design of the measurement structure from stage 3 are combined to create a storable, structural element 1004. As displayed in FIG. 11 the structural element is then organized and stored in a repository of structural elements organized by a multiplicity of categories which contain activity-based autonomous functions that can be executed upon request.

The element structure contains information regarding the observed mass and the action number. The observed mass is the number of actions necessary to power the autonomous experience element, which is an indirect indicator of the amount of computational power needed to execute the experience 1101. The action number is the baseline number of executed actions that can be used to produce results of correlated with the personalization instance 1102.

In FIG. 12 outlines the repository of structural elements identified by system or administrator—elements are formalized and categorized by strategy and utility within the system with the option to deploy as machine learning training models or instances of data driven automation experiences native to insights collected within a system or set of systems. These models are stored and deployed in alignment with an enterprise's strategic goals and key performance indexes and then trigged by predefined measurement analytics and insights to either correct, establish, enhance or decommission system functions. Examples of categories within this repository of data driven experiences included: automated sales strategies, automated spend reduction packages, automated measurement recalibration packages, automated information security strategies.

1.-110. (canceled)

111. A multidisciplinary database management method comprising:
categorizing data from a plurality of sources of a system into one of a plurality of spatial dimensions (0-4), one category for each source, to design a data architecture with five distinct dimensional classifications (0-4) that categorize data into: identification elements (0D) having a single value, descriptive elements (1D) having a single dimension in the data, momentum elements (2D) having two dimensions of variation in the data, analytics elements (3D) having three dimensions of variation in the data, and feedback loop elements (4D) within technology environments having four dimensions of variation in the data, wherein each classification is defined by its respective spatial dimension characteristics;
quantifying an amount of energy that each data element possesses as an operational cost to further process each data element within the system to produce a computational congruence when comparing data operations on data from the respective sources; and
producing a personalization in a computing system based on the categorizing of the data and detection of a change in the quantified energy from at least one of the data sources relative to a predefined measurable goal.

112. The multidisciplinary database management method of claim 111, wherein:
the categorizing data into one of the plurality of spatial dimensions (0-4), are as defined in physics and the categorizing is an indirect indicator of an amount of computational energy needed to produce the personalization; and
said classifications facilitate enhanced data organization, processing, or analysis based on the properties of each spatial dimension characteristic.

113. The multidisciplinary database management method of claim 112,
within a data warehouse, wherein said classifications are chosen to enhance dimensional properties to optimize each of a data storage operation, a retrieval operation, and a computational efficiency.

114. The method of claim 111, wherein the identification elements (0D) include a unique identifier for each of the entities associated with the respective data within the system.

115. The method of claim 114, wherein the demographic elements (1D) provide a context for each entity within the system based on an attribute associated with each respective entity.

116. The method of claim 115, wherein the momentum elements (2D) include data which reflect changes and interactions over time of respective entities, offering an observable insight into entity behavior within the momentum elements (2D).

117. The method of claim 111, wherein the analytics elements (3D) facilitate the derivation of insights through data analysis and interpretation to enable a customer targeting.

118. The method of claim 111, wherein the feedback loop elements (4D) enable dynamic adjustments based on the quantified amount of energy of the respective data elements within the system and optimizations based on an outcome determined in real-time.

119. The method of claim 111, further comprising employing the data architecture to improve the accuracy or efficiency of a measurement derived from data captured by the system against a predefined goal.

120. The method of claim 111, wherein real-time measurement capabilities are enhanced through application of 2D momentum elements.

121. The method of claim 111, wherein the data architecture supports the implementation of predictive analytics through 3D analytics elements categorized as analytics elements (3D).

122. The method of claim 111, further comprising utilizing the data architecture to each data source of a cloud computing environment.

123. (canceled)

124. (canceled)

125. The method of claim 111 wherein the data architecture incorporates encryption and a security measure within the 0D classification to protect a sensitive identification element.

126. The method of claim 111, further comprising:
customizing a user experience in a user interface based on data categorized within a 1D classification and a 2D classification.

127. The method of claim 111 wherein the data architecture enables the automated generation of feedback based on a user interaction within a feedback loop elements (4D).

128. The method of claim 111, further comprising the integration of the data architecture into a unified data structure in addition to existing data processing and management systems to enhance their functionality.

129. The method of claim 111, wherein the data architecture is applied across a plurality of environments, including two or more of a blockchain, ETL, OLTP, OLAP, and API-based environments.

130. The method of claim 111, further comprising leveraging the data architecture in a Star-based data warehouse or a Snowflake-based data warehouse.

131. The method of claim 111, wherein data warehousing is optimized through the application of said dimensional classifications such that the change in the quantified energy is associated with an operation cost of one data source of the system, wherein producing a personalization includes displaying a selectable personalization on a reporting dashboard.

132. The method of claim 111, wherein the method further comprises:
generating a list of next-best-actions; and
generating a next-best-action report for a personalization output.
